(19) United States
(12) Patent Application Publication
(10) Pub. No.: US 2017/0251651 A1
(43) Pub. Date: Sep. 7, 2017

(54) FISHING POLES

(71) Applicant: Richard R. Beauchamp, Pawtucket, RI (US)

(72) Inventor: Richard R. Beauchamp, Pawtucket, RI (US)

(21) Appl. No.: 15/446,777

(22) Filed: Mar. 1, 2017

Related U.S. Application Data
(60) Provisional application No. 62/302,349, filed on Mar. 2, 2016.

(51) Int. Cl. A01K 87/02; A01K 99/00; A01K 87/04

(52) U.S. Cl. CPC A01K 87/02; A01K 87/04; A01K 99/00

(57) ABSTRACT

An elongated fishing rod assembly with a top section having at least one eye loop, a middle section, and a bottom section having a reel mounted thereto. Each of the three sections have a distal and a proximal end. The top proximal end has a male connector. The middle distal end has a female connector for coupling with the top male connector. The middle proximal end has a middle male connector, substantially the same as the top male connector, for coupling with a female connector on the distal end of the bottom section. A method of fishing where a fishing pole with a top, middle and bottom section is assembled with the top, middle and bottom sections for casting. The middle section is removed after casting, and the fishing pole is reassembled with the top section directly connected to the bottom section.

### CROSS-REFERENCE TO RELATED APPLICATION

This application claims priority to U.S. Provisional Patent Application No. 62/302349, filed, Mar. 2, 2016, which is incorporated herein by reference.

### FIELD OF THE INVENTION

The subject disclosure relates to fishing poles or rods, and more particularly to fishing poles or rods that can be adjusted for various applications and events during fishing.

### BACKGROUND OF THE INVENTION

Basic fishing pole rod and reel construction have been known and used by sport anglers for a considerable period of time. As sport fishing has become more sophisticated, modifications of the equipment have become imperative in order to optimize the ability to catch different species of fish under various conditions. The discerning angler requires equipment that will adapt to the type of fish and conditions in which fishing is accomplished. The usual fishing practice involves carrying several types of rods for different types and styles of fishing, so a fisherman may fish under a variety of conditions. This practices is burdensome, inconvenient, and expensive.

### SUMMARY OF THE INVENTION

As is often the case with fishing, fishing situations may call for the use of a fishing pole that enables length adaptation. A need exists for a fishing pole that quickly and easily converts between a long fishing pole for casting and other times to a shorter fishing pole for reeling and other activities. For example, a 14 foot fishing pole is advantageous in casting far but, it is difficult when reeling in a fish on such as long pole. A 10 foot pole on the other hand, is much easier to reel in your catch but cannot match the distance of the cast from a 14 foot fishing pole. In order to provide for such contingencies, the applicant has devised a fishing pole capable of innovatively adapting fishing pole length.

The subject technology includes an elongated fishing rod assembly with a top, middle and bottom section. The top section has a top proximal end and a top distal end. The top distal end has a top male connector. The top section also has at least one eye loop. The middle section has a middle distal end and a middle proximal end. The middle distal end has a middle female connector for coupling with the top male connector. Thus, the middle section may connect with the top section. The middle proximal end has a middle male connector substantially the same as the top male connector. The bottom section has a reel mounted thereto and a bottom distal end. The bottom distal end has a bottom female connector for selectively coupling with the top male connector or the middle male connector. Thus, the bottom section may connect to the middle section or the top section. In some embodiments, the fishing rod is 14 feet long including a 5 foot bottom section, a 4 foot middle section, and a 5 foot top section. There may be at least one eye loop on the middle section and at least one eye loop on the bottom section. The male and female connectors may be formed by metal inserts. Indicia on each section may exist to indicate appropriate rotational alignment between the sections when they are connected.

The subject technology also relates to a method of fishing, where a fishing pole with a top, middle and bottom section is assembled with the top, middle and bottom sections for casting. The middle section is removed after casting, and the fishing pole is reassembled with the top section directly connected to the bottom section. In some embodiments, alignment indicia are provided on the top, middle and bottom sections.

The subject technology includes an elongated fishing rod assembly with a top, middle and bottom section. The top section has a top proximal end and a top distal end, wherein the top proximal end has a top male connector. The top section has at least one eye loop. The middle section can connect with the top section. The middle section does not have any eye loops. The middle section has a middle distal end and a middle proximal end. The middle distal end has a middle female connector for coupling with the top male connector. The middle proximal end has a middle male connector. The bottom section may connect with the middle section. The bottom section has a reel mounted thereto and a bottom distal end. The bottom distal end has a bottom female connector for selectively coupling with the top male connector or the middle male connector. In some embodiments there are indicia on each section for rotational alignment.

It should be appreciated that the subject technology can be implemented and utilized in numerous ways, including without limitation as a process, an apparatus, a system, a device, a method for applications now known and later developed. These and other unique features of the system disclosed herein will become more readily apparent from the following description and the accompanying drawings.

### BRIEF DESCRIPTION OF THE DRAWINGS

So that those having ordinary skill in the art to which the disclosed technology appertains will more readily understand how to make and use the same, reference may be had to the following drawings.

FIG. 1 is a side view of a fishing pole in accordance with the subject technology.

FIG. 2 is an exploded view of a fishing pole in accordance with the subject technology.

FIG. 3 is an exploded view of another fishing pole in accordance with the subject technology.

FIG. 4 is an exploded view of still another fishing pole in accordance with the subject technology.

FIG. 5A is an exploded view of yet another fishing pole in accordance with the subject technology.

FIG. 5B illustrates an alternative section for use with the fishing pole of FIG. 5A in accordance with the subject technology.

### DETAILED DESCRIPTION OF PREFERRED EMBODIMENT

The subject technology overcomes many of the prior art problems associated with fishing poles. The advantages, and other features of the systems and methods disclosed herein, will become more readily apparent to those having ordinary skill in the art from the following detailed description of certain preferred embodiments taken in conjunction with the drawings which set forth representative embodiments of the present invention.

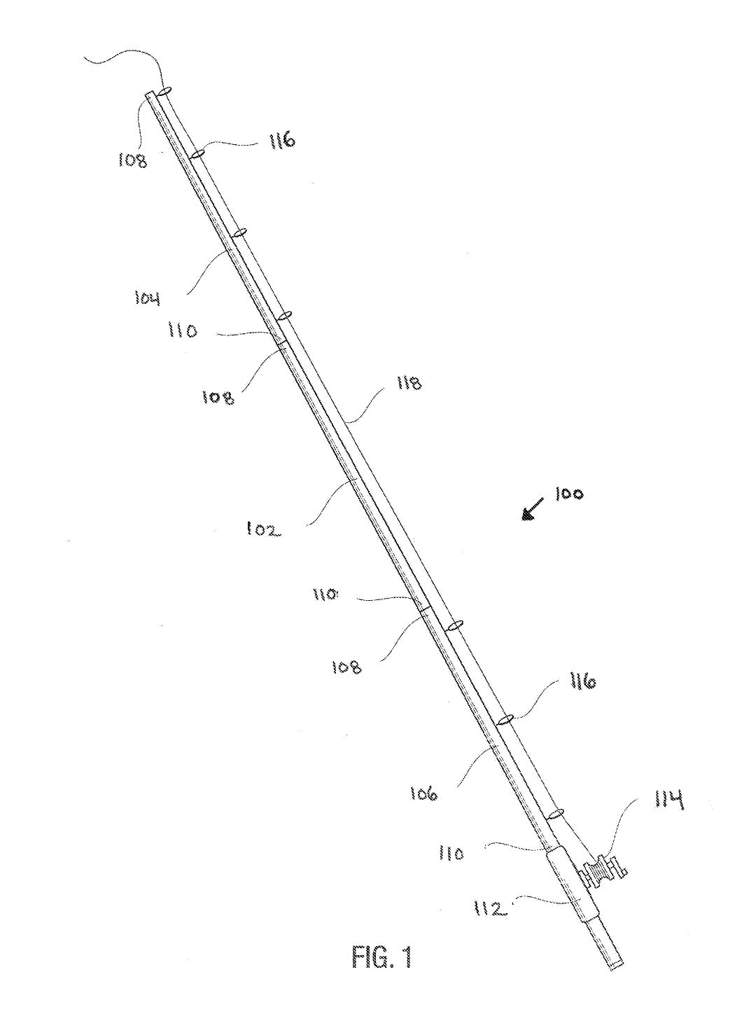

Referring now to FIG. 1, there is shown a fishing pole (100) having a middle section (102) with no eye loops. As such, the fishing pole can advantageously have the middle section (102) easily removed and/or replaced after casting in order to shorten a length of the fishing pole (100). It is envisioned that the top (104), middle (102) and bottom (106) sections may be various materials to adjust the properties thereof such as the strength, flexibility, durability and the like. The top (104), middle (102), and bottom (106) sections of the fishing pole (100) each have a distal end (108) and a proximal end (110) relative to the padded grip (112) and reel (114). The top and bottom sections of the fishing pole contain eye loops (116) through which the line (118) is threaded. The fishing pole (100) may be used to for bottom fishing in salt water with bait, surf casting, fly fishing and the like. In one embodiment, an overall length of the fishing pole is 14 feet.

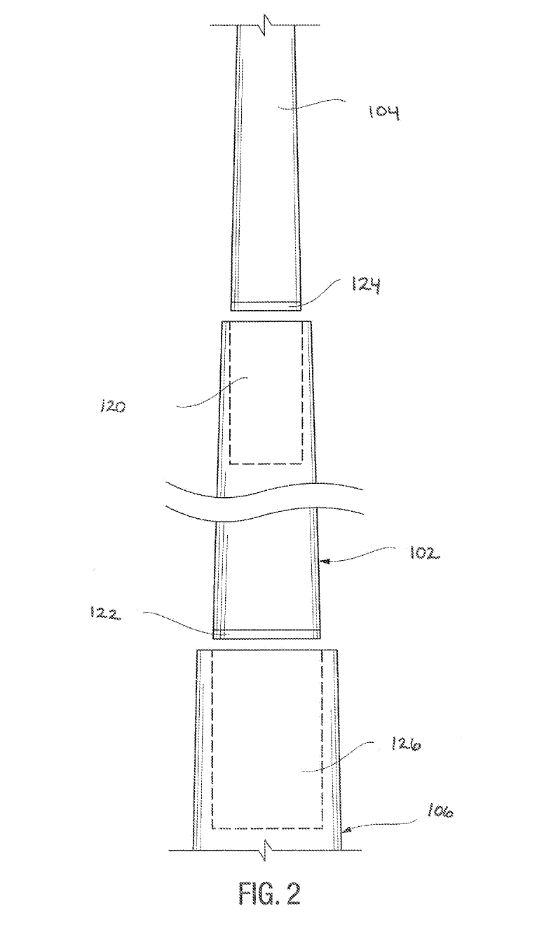

Referring now FIG. 2, an exploded view of a fishing pole (100) is shown in accordance with the subject technology. The fishing pole includes a middle section (102) without eye loops and alternative middle sections (not shown) that may be of varying lengths. As a result, the longest middle section may be utilized for casting, then an alternative length middle section may be utilized for the remainder of the fishing activity such as reeling in the big one. It is envisioned that although the various middle sections (102) vary in length, each has a middle female connector (120) on the distal end (108) and a middle male connector (122) on the proximal end (110) that make the various middle sections interchangeable. Additionally, the top section (104) will have a top male connector (124) on its proximal end (110) which could join with a middle female connector (120). The bottom section (106) will have a bottom female connector (126) which could join with a middle male connector (122). Preferably, the connectors thread together, couple by interference fit, include a bore (keyed or otherwise) that receives a button (spring loaded or otherwise), and like connection methods now known and later developed. The bottom section (106) may be 5 feet long, the middle section (102) 4 feet long, and the top section (104) 5 feet long. As shown in FIG. 2, an adapter ring or fixture (not shown) may be necessary to secure the top section (104) and the bottom section (106) together.

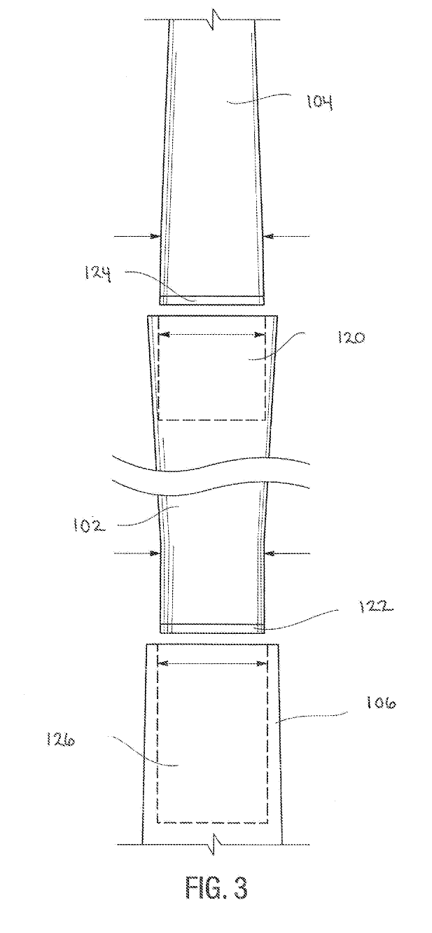

Referring now to FIG. 3, an exploded view of another fishing pole (100) is shown. Many elements are essentially the same as those of the foregoing embodiments and, thus, are not further described herein. The primary difference of the fishing pole (100) is the middle section (102) having a reverse taper as compared to traditional middle sections. The reverse taper allows the middle female connector (120) and the bottom female connector (126) to be substantially the same. Additionally, the reverse taper allows the middle male connector (122) and the top male connector (124) to be substantially the same. As a result, the fishing pole (100) can be assembled with the middle section (102) or with the top section (104) connecting directly to the bottom section (106) as desired. It is envisioned that the fishing pole could have multiple middle sections (102) so that 4, 5, 6 or more sections may be combined to vary the length of the fishing pole (100) at various times.

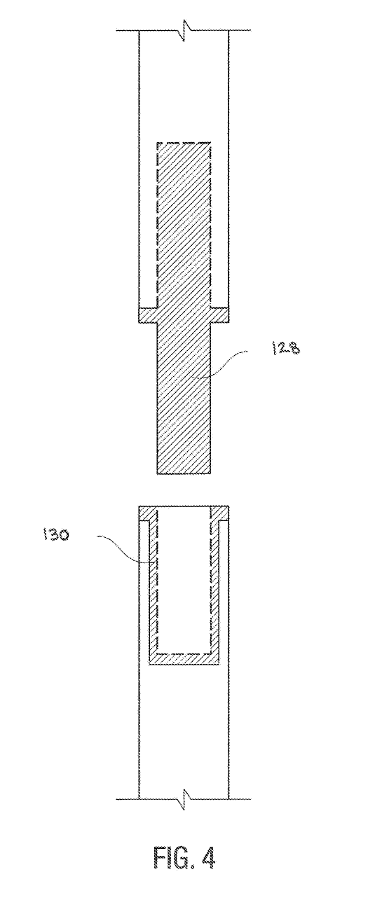

Referring now to FIG. 4, an exploded view of still another fishing pole (100) in accordance with the subject technology is shown. Many elements are essentially the same as those of the foregoing embodiments and, thus, are not further shown or described herein. The primary difference of the fishing pole (100) is the inclusion of metal inserts for facilitating selectively joining two sections. The metal inserts include a male metal insert (128) and a female metal insert (130), each of which is glued, screwed and/or otherwise secured to the respective section. Again, friction fit ridges or rings, spring loaded buttons with detents, cotter pins into throughbores, and the like can be utilized to easily and make and undo the connection. Alternatively, the inserts are plastic.

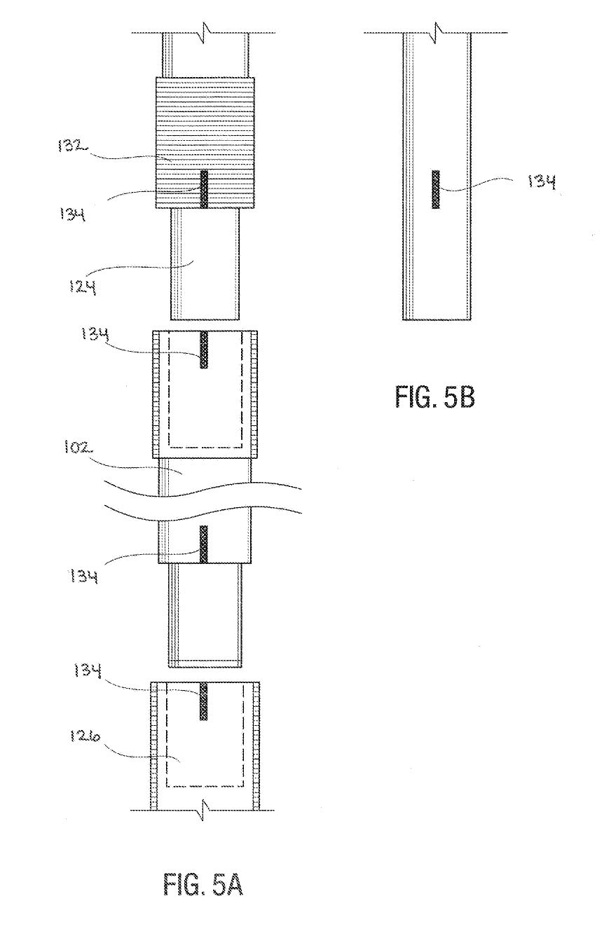

Referring now to FIG. 5A, an exploded view of yet another fishing pole (100) in accordance with the subject technology is shown. Many elements are essentially the same as those of the foregoing embodiments and, thus, are not further shown or described herein. The primary difference of the fishing pole (100) is the use of resin coated thread (132) for strengthening the connection points and alignment indicia (134) for aligning the sections for proper orientation when connected. The alignment indicia (134) is matched to the eye loops so that when assembled with the alignment indicia aligned, the eye loops are perfectly aligned.

FIG. 5B illustrates an alternative section for use with the fishing pole (100) of FIG. 5A in accordance with the subject technology. The embodiment of FIG. 5B simply has alignment indicia (134) without the resin coated thread reinforcement (132).

In another embodiment, the fisherman may simply desire to leave the fishing pole fully assembled and add one or more eye loops onto the middle section. The eye loops may be selectively added before or after assembly. For example, the additional eye loop(s) may clip onto the middle section and have a slot, key ring or paper clip type arrangement so that the line can be threaded into the loop. The eye loop may attach by a fastener, a belt arrangement, a clip, a snap-fit, a twist-lock or other arrangement so that the eye loop can be selectively removed if desired.

It will be appreciated by those of ordinary skill in the pertinent art that the functions of several elements may, in alternative embodiments, be carried out by fewer elements, or a single element. Similarly, in some embodiments, any functional element may perform fewer, or different, operations than those described with respect to the illustrated embodiment. Also, functional elements (e.g., eye loops, reel mounts and the like) shown as distinct for purposes of illustration may be incorporated within other functional elements in a particular implementation.

It is also envisioned that the subject technology may be provided as a kit for retrofitting existing fishing poles. The fisherman may purchase one or multiple middle sections without eye loops for temporarily modifying a rod during casting. Preferably, the middle section is 4 feet long for use in retrofitting a 10 foot long pole. Further, the kit may simple be or include one or more couplers that allow mating various sections together selectively. Although the subject technology has been described with respect to the field of a single fishing rod, it is envisioned that the subject technology would be equally applicable to other fields and applications such as on lacrosse sticks, hockey sticks, baseball bats and fungos, snow shovels, pool skimmers, rakes for the roof and otherwise, and the like.

While the subject technology has been described with respect to preferred embodiments, those skilled in the art will readily appreciate that various changes and/or modifications can be made to the subject technology without departing from the spirit or scope of the invention as defined by the appended claims. For example, each claim may depend from any or all claims in a multiple dependent manner.

While the subject technology has been described with respect to preferred embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed.

What is claimed is:

1. An elongated fishing rod assembly comprising:
a top section having a top proximal end and a top distal end, wherein the top proximal end has a top male connector;
at least one eye loop on the top section;
a middle section connected to the top section, wherein the middle section having a middle distal end and a middle proximal end, the middle distal end has a middle female connector for coupling with the top male connector, and the middle proximal end has a middle male connector substantially the same as the top male connector; and
a bottom section connected to the middle section, wherein the bottom section having a reel mounted thereto and a bottom distal end, the bottom distal end having a bottom female connector for selectively coupling with the top male connector or the middle male connector.

2. An elongated fishing rod assembly as recited in claim 1, wherein the fishing rod is 14 feet long including a 5 foot bottom section, a 4 foot middle section, and a 5 foot top section.

3. An elongated fishing rod assembly as recited in claim 1, further comprising at least one eye on the middle section and at least one eye loop on the bottom section..

4. An elongated fishing rod assembly as recited in claim 1, wherein the male and female connectors are formed by metal inserts.

5. An elongated fishing rod assembly as recited in claim 1, further comprising indicia on each section for rotational alignment.

6. A method of fishing comprising the steps of:
providing a fishing pole with a top, middle and bottom section;
assembling the fishing pole with the top, middle and bottom sections;
casting;
removing the middle section after casting; and
reassembling the top section directly to the bottom section.

7. A method as recited in claim 6, further comprising the step of providing alignment indicia on the top, middle and bottom sections.

8. An elongated fishing rod assembly comprising:
a top section having a top proximal end and a top distal end, wherein the top proximal end has a top male connector;
at least one eye loop on the top section;
a middle section connected to the top section, wherein the middle section does not have any eye loops, the middle section has a middle distal end and a middle proximal end, the middle distal end has a middle female connector for coupling with the top male connector, and the middle proximal end has a middle male connector; and
a bottom section connected to the middle section, wherein the bottom section having a reel mounted thereto and a bottom distal end, the bottom distal end having a bottom female connector for selectively coupling with the top male connector or the middle male connector.

9. An elongated fishing rod assembly as recited in claim 8, further comprising indicia on each section for rotational alignment.
